(19) United States
(12) Patent Application Publication
(10) Pub. No.: US 2008/0255948 A1
(43) Pub. Date: Oct. 16, 2008

(54) VENTURE FUND INVESTING POINTS CARD

(76) Inventor: William J. GARNER, Leawood, KS (US)

Correspondence Address: BUCHANAN, INGERSOLL & ROONEY PC, POST OFFICE BOX 1404, ALEXANDRIA, VA, 22313-1404, US

(21) Appl. No.: 12/100,898

(22) Filed: Apr. 10, 2008

Related U.S. Application Data
(60) Provisional application No. 60/907,597, filed on Apr. 10, 2007.

(51) Int. Cl. G06Q 40/00

(52) U.S. Cl. 705/14

(57) ABSTRACT

A process of controlling transaction cards to provide benefits of a rewards program contribution to a venture fund, which serves to identify potential investors through an application process for financial transaction card offerings, allowing recipients of the venture card to make purchases of products and services using the venture fund card, and taking a portion of the transaction value of a transaction to be used by one or more venture funds. Venture fund card activity statements to individual cardholders can include additional information regarding fund or funds in which the cardholder has invested or potential investment opportunities. Cardholders could be provided with an option to increase holdings in a particular venture fund associated with the venture fund card, or to liquidate investments in the associated venture funds.

### FIELD OF THE EXEMPLARY EMBODIMENTS

The disclosed embodiments relate to a method and system for controlling data bearing records, such as credit, debit or other financial transaction cards, such that benefits of a rewards program contribute to a venture capital account.

### BACKGROUND

Credit cards that provide “reward points” as an incentive for the card holder to use the card are known. They are summarized in the following table.

| | Air Miles | Cash Back | Charitable |
|---|---|---|---|
| Points Rewards | Rewards | Rewards | Rewards |
| Points awarded for | “Free” flights, | Diverts a portion | Provides the |
| every $1 spent on | upgrades, and | of the transaction | cardholder with an |
| credit card | other benefits are | value back to the | opportunity to help |
| purchases. Points | earned by simply | cardholder, the | his or her favorite |
| may be redeemed | using your credit | portion potentially | charity by |
| for gift certificates, | card for all your | varying depending | diverting a portion |
| merchandise, air | purchases. One or | on the type of | of the transaction |
| travel, hotel stays, | more “miles” | purchase, e.g., up | value to a charity |
| etc. Redemption | awarded for every | to 5% on some | selected by the |
| starts a given | $1 spent. | cardholder's | cardholder. |
| threshold, e.g., | Redemption starts | purchases, and as | |
| 1000 points. | at given thresholds | high as 10% on | |
| | for given flights, | gasoline. | |
| | e.g., 19,200 | | |
| | “miles” for a | | |
| | domestic | | |
| | roundtrip. | | |

When the credit card is used to purchase merchandise or services, rewards points or cast rebates accrue to the benefit of the cardholder. Typically, when enough reward points accrue, the cardholder can redeem the reward points by purchasing products or services, either in whole or in part, using the reward points from the business or businesses associated with the points program, once the card holder has accrued enough reward points to qualify for the products or services. An example of a reward is a free upgraded airline ticket if the cardholder charges a predetermined dollar amount usually over a predetermined period of time. The idea is to entice the user to use the particular credit card for his or her purchases in order to accumulate enough reward points to obtain the airline ticket, and the airlines, for instance, offer discounted airfares to further this incentive and to use the participating airline.

The number of reward points earned is, typically, based on a percentage of the total dollar amount that the card holder charges to the credit card. The value of the points is derived from the transaction fees charged to the merchants for the patron's use of his or her card, and but discounts or other forms of subsidies offered by companies associated with the rewards program (e.g., airlines frequent flier programs, hotel points, etc.). The reward points can take the form of frequent flier miles, points towards gifts (e.g., pre-paid gift cards, merchandize, magazine subscriptions, and the like) assigned a specific reward point value, investments in a retirement account, and similar types of things or services considered of value to a card holder.

For example, as shown in FIG. 1, credit card holder A (110A), credit card holder B (110B), credit card holder C (110C), each have a credit card that allows them to receive “rewards points” for using credit cards issued by or for a card issuer 150 to make purchases. The credit card holder A (110A), for example, can make a purchase at any number of merchants (e.g., merchant A (120A) or merchant B (120B)) participating in the credit cards transaction system, using the credit card. The purchases may be made using either the physical credit card or the credit card account number, such as in an on-line store. The transaction between the credit cardholder A (110A) and the merchant A (120A) or B (120B) is processed through the credit card issuer or processing center 150. The credit card issuer 150 can process its own transactions (e.g., check available credit limit, approve or declining transactions, etc.), or can rely on a third party credit card processor to do the same, or combinations thereof. The credit card issuer/processing center 150 can be associated with a business or businesses 140 that will redeem the reward points for products or services.

The reward points accumulate in an account managed by either the card issuer 150 or the business 140 or a third party, e.g., rewards account manager 130. When the card holder 110A-110C wishes to convert the reward points into the subject of the reward (e.g., an airline ticket), the card holder 110A contacts the rewards account manager 130, for instance, to exchange the reward points, and obtain the “reward.” The account is then debited the number of reward points exchanged for the reward.

Upon satisfactory completion of the transaction, the card issuer/processing center 150 on a periodic basis, e.g., monthly, will resolve with the reward account manager 130 the transaction amounts for each of cardholder A (110A), cardholder B (110B) and cardholder C (110C). The rewards account manager 130 will determine the total amount (e.g., total purchases, eligible purchases, percentage of the purchases, etc., depending on the card offering) that are eligible for accruing reward points and allocate the accrued reward points to each of cardholder A (110A) through cardholder C (110C).

The reward point account balance is managed in a number of different ways. For example, the accumulated reward points can be held for only a predetermined amount of time (e.g., two years) after the cardholder stops using the associated credit card, or until the account is cancelled by the user, whichever is sooner. In other words, the accumulated reward points must be exchanged within a certain timeframe before they expire.

However, cardholders often accumulate more points than they might reasonably expect to use when the reward points are tied to a particular type of service (e.g., air travel). In other cases, the reward points are not of particular interest in that the potential rewards are not of sufficient value, particularly to wealthier or inattentive individuals. In still other cases, such as in a retirement account example, the reward points accumulate in an account until there is enough to buy a share of the retirement account fund. Once enough reward points are, in their associated monetary value, equal to a share, a share in the retirement account fund is purchased in the name of the card holder and placed in the retirement account in the cardholder's name. However, retirement accounts are often funded through other means and the actual benefits are too far off into the future and/or too small to be of sufficient interest to many cardholders.

There are also credit cards that allow the cardholder's reward points to be invested in stocks associated with a corporation for which the cardholder works, and to also liquidate the held stock, but this may be viewed as too limiting and not permitting a diversified enough portfolio or not matching the cardholder's potential investment interests.

There is also the issue of the rewards being of relatively small value. Unlike frequent flier miles, where the airline discounts the airline ticket or otherwise effectively subsidizes the rewards program, buying stock usually would not permit such discounts, the rewards from such cards might seem to be a mere trickle to the cardholder. Further, other incentive programs may seem more attractive because of subsidies offered by the affiliated companies. For instance, an individual cardholder's spending activities may only garner him one share of stock every six months at a value measured in tens of dollars, where the same activity will permit him an upgrade on his next airline flight, which would reasonably be perceived as greater reward even though he might be purchasing a $250 ticket with 25,000 frequent flier miles at a par value of just $0.01 per dollar spent.

Other cards, known as affinity cards, permit a person to identify him or herself as being associated with a particular organization or institution, such as a particular charity or university. Such cards often provide cash benefits to the institution as a reward for attracting card members. The cardholder may or may not see any direct personal benefit, other than being associated with the particular institution.

By way of additional background, there is a class of investors known as “accredited investors” or “qualified purchasers.” An accredited investor as referred to by the Securities Exchange Commission under Regulation D is an investor having knowledge and experience in financial and business matters such that he is capable of evaluating the merits and risks of a prospective investment. Specific criteria for being classified as an accredited investor include an investor who earns a significant income (e.g., an individual income in excess of $200,000 in 2007 dollars in each of the two most recent years or joint income with that person's spouse in excess of $300,000 in 2007 dollars in each of those years and has a reasonable expectation of reaching the same income level in the current year), or who has a high individual net worth, or joint net worth with that person's spouse, at the time of his purchase or investment (e.g., exceeds $2,500,000 in 2007 dollars).

These accredited investors are particularly attractive to start-up companies and venture funds because they are capable of investing significant sums of money and require a lower (and therefore less burdensome) level of financial disclosures under relevant regulations. Accredited investors can be difficult to identify in that information about financial well-being is generally regarded as private information. Many accredited investors do not know they have this status, or that potential investment opportunities await them.

### SUMMARY

There is a perceived need for a product that allows cardholders an opportunity to invest in fast-growth investment vehicles, such as venture funds, that have the prospect for a high return on investment, with of course a commensurate risk of loss, so that the small amount of value generated through a rewards program can lead to a potential substantial reward, in order to attract cardholders.

Additionally, there is a need for a method of identifying persons, particularly people who are accredited investors, who are capable of investing, and desire to invest, in start-up companies or other ventures that are high risk. Among such persons are the so-called “angel” investors.

An exemplary embodiment of the present disclosure is a process of controlling transaction cards to provide benefits of a rewards program contribution to a venture fund that includes the steps of: permitting a potential investor to apply for a venture fund transaction card; approving and issuing venture fund transaction cards to qualified cardholders as a result of a review of their qualifications against predetermined criteria; permitting use of issued transaction cards after a check on whether the use of the transaction card is appropriate at the time of the transaction, to make purchases of one or more of products and services; taking a portion of the transaction value of a transaction to be used by one or more venture funds; and providing cardholders an opportunity to liquidate investments in said one or more venture funds.

In addition, the exemplary process can further include issuing statements to individual cardholders having additional information regarding fund or funds in which the cardholder has invested or might be interested in investing.

In addition, the exemplary process can further include providing cardholders the option to increase holdings in a particular venture fund associated with the venture fund card.

In addition, the exemplary process can further include soliciting potential investors having said predetermined criteria qualifications to apply for the venture fund transaction card through marketing directed to those interested in a particular affinity category.

### BRIEF DESCRIPTION OF THE DRAWING FIGURES

The foregoing, and other, objects, features and advantages of the disclosed embodiments will be more readily understood upon reading the following detailed description in conjunction with the drawings in which:

FIG. 1 shows a common rewards based credit card distribution and transaction system;

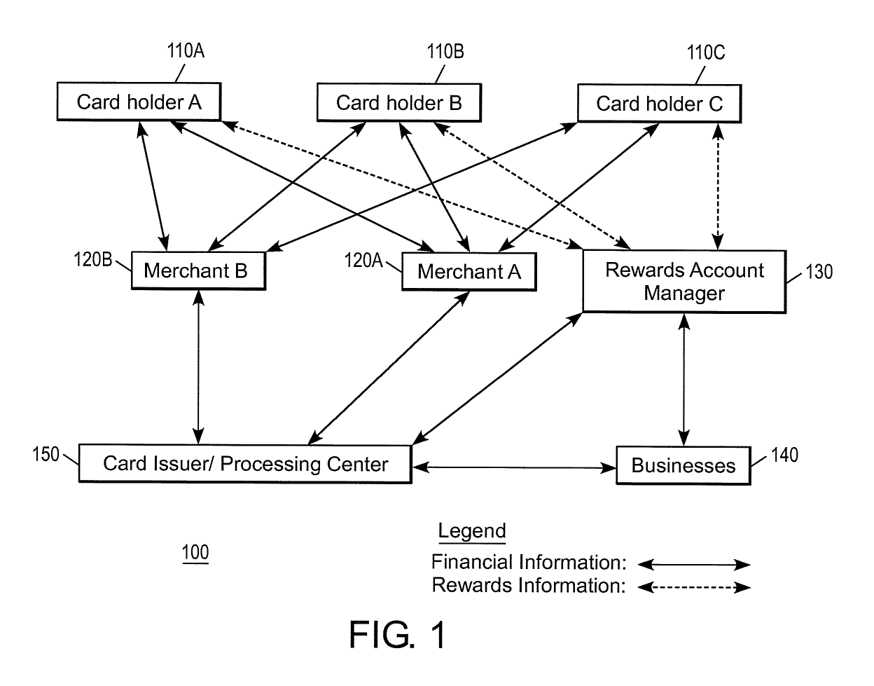

FIG. 2 is a flowchart illustrating an exemplary process of the investor card system of the present disclosure;

FIG. 3 illustrates the intake process for identifying new subscribers to the credit card accounts according to an exemplary embodiment of the present disclosure;

FIG. 4 illustrates the distribution of transaction fees associated with the use of the credit card and system components used for implementing the described method according to an exemplary embodiment of the present disclosure;

FIG. 5 illustrates the distribution of information regarding the investments made on behalf of the credit card holders according to an exemplary embodiment of the present disclosure; and

FIG. 6 illustrates an exemplary credit card for carrying out the exemplary method explained with reference to FIGS. 2-5.

### DETAILED DESCRIPTION

To facilitate an understanding of the present disclosure, it will be divided into four parts including an overview, a system of identifying potential card members—particularly accredited investors, a system of processing card transactions and calculating rewards, and a method of distributing those rewards.

It should be noted initially that as used below “transaction cards” refers to any form of financial transaction card, whether physical or virtual, that can be used in the purchase of products or services, including but not necessarily limited to credit cards, debit cards, smart cards, travel cards, corporate cards, business cards, gift cards, to name a few. The term also applies to alternative payment methods such as PayPal™, if these alternative payment methods should offer or start to offer reward points. “Reward points” refers to both a system were “points” are assigned to specified transactions amounts (e.g., one point for each dollar spent) or direct diversion of cash (e.g., $0.05 for each dollar spent) without conversion. “Venture funds” include funds capable of fast growth, e.g., with a potential return on investment (ROI) that is a relatively high return on the initial investment (e.g., in excess of 100%), such as but not limited to early stage (a.k.a. seed stage or angel) funds, venture capitalists (VC) funds, investment banker funds, and hedge funds, and should be construed as including investment in individual companies, small groups of companies or large portfolios of companies. Such funds have managers, who oversee the cardholder's accounts with respect to the investments and investment opportunities for a salary or a fee, potentially a fee based on a percentage of the total monetary value of the fund. As such, venture funds can include direct investment in start-up companies, and, because of the potential for a high rate of return and the potential affinities of the investors, start-up companies founded around innovation are particularly attractive. “Cardholder” is interchangeable with “card member” and can be an individual or other legal entity. The cardholder might be a primary cardholder with separate dependent cards for his or her spouse and/or children or similar hierarchies, and the fund or funds being invested in being common or associated with each dependent card. The venture fund card can be stand-alone, or combined with other card programs, such as but not limited to those card program identified above.

### Overview

As mentioned above, rewards programs can be viewed as funded by merchants that pay a transaction fee of 2-4%, for example, of the net or total transaction value in which a patron uses a transaction card, the amount of the transaction fee depending on the agreement between the merchant and the card issuer. While this transaction fee may be divided up among card associations, card issuers and card processors for example, a portion is be diverted to the venture fund as explained below either via redemption of points or by direct investment of the transaction fees on a periodic basis (e.g., daily when transactions are cleared, monthly, or when a sufficient amount of points or cash is accumulated in the individual's reward program account). For example, if a transaction of $100.00 incurs a $4 transaction fee, paid by the merchant or cardholder or by contributions of each, the transaction fee may be split between the card issuer (and, if separate, one or more card processors or intermediaries) and the venture fund. For instance the venture fund might get $2 of the $4, for investing. This might be done by letting the card holders accumulate points, and the points periodically converted to legal tender representing cash to be deposited in a cash management account, which would in most instances be interest bearing. The fund manager could then access funds from the account in high risk, high potential return investments, and place money back into the management account when investments are liquidated. The card holder's interests in the investments and the account would be tracked as reported to the cardholder, usually as part of his or her card activity statements and/or on-line. The fund manager would be paid based on the size of the fund, either measured as the amount invested, the total amount of the investments plus the money held in the management account, or nearly any other arrangement agreed upon by the respective parties. The fund manager could be paid by the card holders, by the card issuers or by each contributing to the manager's fees.

The cardholder might think of this benefit as not costing her anything, and so might view the benefits as “found money” that can be more easily spent, and the rewards feel like winning a prize. A problem with cards that divert money to a retirement or other conventional investment fund is that it takes too much time to build a significant reward. Plus, the investment vehicles can be quit limited and do not generally take into consideration the cardholder's interests or affinities in particular market sectors. For instance, the cardholder might be interested in biotechnology, information technology, and electronics, to name a few, and want to feel a part of or supporting of the innovations that are changing the world.

Additionally, cardholder information is protected by privacy laws and restrictive agreements between cardholders and the card issues. Wealthy individuals in particular might be displeased by the unauthorized release of their income and worth information, as disclosed to acquire a credit card or as implied by their credit card usage, and particularly by the unauthorized release of their private information to those seeking investors in venture funds or start-up companies.

The present disclosure avoids these problems by providing incentives to potential investors to identify themselves and their potential interest in making highly speculative investments. As disclosed in greater detail below, this is done by offering a transaction card product that uses a portion of the transaction fees to invest or provide information as to potential investments, or to defray the costs associated with running a venture fund (which can have a significant impact on the return on investment (ROI)), or by providing information about potential investments through a service for which they might otherwise have to pay.

The cardholders are not confronted with requests for payments in these investments (though there can be subscription or annual fees for being a card holder), but instead realize that their transaction card usage has the potential of reaping multiples of their initial investment that is made without direct impact on their income or wealth. If the investment returns nothing, then the perception would be nothing was lost, particularly for cardholders who do not focus on their rewards program options, such as those who hold more rewards points than they might be reasonably expected to cash-in or who are generally inattentive. For instance, a person with hundreds of thousands of frequent flier mileage points might periodically take a trip with friends or family to use the points, but this can be perceived as more trouble than it is worth to some, particularly factoring the time and hassle necessary to carry out the process of redeeming miles, blackout dates, and other inconveniences.

The present disclosure provides an outlet for people who might want to see these rewards points put to better use, are interested in seeing a significant return on investment, might be interested in learning about potential opportunities, and/or might be interested in having an affinity card that provides a potential return. This is accomplished by a simple rewards program with the promise of high rewards, potentially in a venture or industry the cardholder already has an affinity towards.

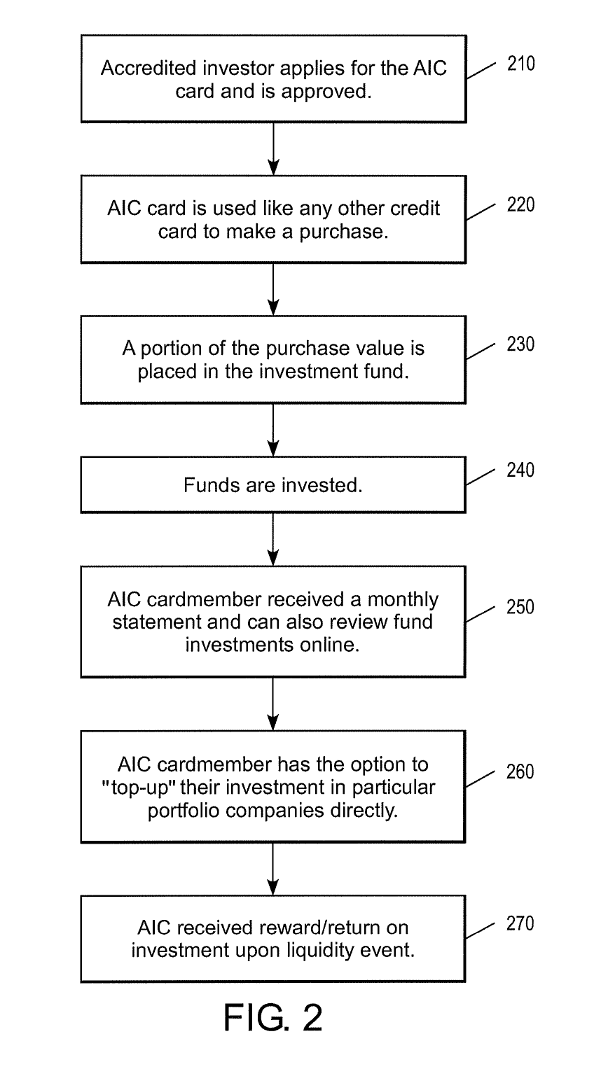

For instance, as shown in FIG. 2, the overall process in accordance with one exemplary embodiment can be as follows. In step 210, an accredited investor, for instance, applies for a venture fund transaction card and is approved after self-accreditation and background checks, such as on his or her credit score. He or she may have been solicited to apply, perhaps by the card issuer or other institution that has or acquires some information or indication that the potential card holder may qualify as an accredited investor. The venture fund transaction card (physical or virtual) is then provided to the cardholder. In step 220, the cardholder uses the transaction card like any other financial transaction card or number to make purchases of products and/or services. In step 230, a portion of the purchase value or a portion of the transaction fee is directly placed in an investment fund, or placed in a management account until sufficient funds have accumulated and/or until the cardholder designates a fund from a group of possible funds if a fund selection option is part of the program. The funds are thus invested with the issuance of an appropriate investment instrument, such as stock, options, warranties or the like, in step 240. As shown in step 250, the cardholder has access to or receives a periodic (e.g., monthly statement), which could be optionally combined or made separate from the cardholders regular card activity statement. Such statements might have additional information and financial disclosures regarding the funds the cardholder has invested in or potential investments available through the program, with potential cost savings for combined mailings, or electronic statements.

In exemplary step 260, the cardholder has the option to “top-up” his or her investment in a particular portfolio or fund, perhaps based on the information disseminated as part of the venture fund card program, and the venture fund card program could in certain embodiments facilitate such additional investments. As shown in step 270, the cardholder would then be entitled to liquidate his investment upon or after a liquidity event, such as acquisition by a publicly or privately held company, or upon the company or companies in which the investment is made going public and after the lock-out period. Such liquidation could be at the cardholders option when such an option becomes available, automatically set-up by the cardholder or the investment fund in advance, etc.

It should be noted here, that due to the venture fund card program having multiple card holders, a market for privately held stock becomes available, at least among the card members. In this way, a cardholder interested in “cashing-in” early could simply inform the fund manager, and the fund manager would have a vehicle through monthly statements or online accounts of advertising the availability of those shares, for instance, to other potential investors. Because the group of investors in this venture fund card program is larger than might otherwise be expected in a conventional investment program, due to the ease and relatively small incremental investments by cardholders, there would be a larger potential market for the privately held stock. Privately held stock is notoriously difficult to divest under typical conventional circumstances.

Meanwhile, the prospective investment opportunities, whether individual companies or venture funds, are attracted to the program because it can provide a steady stream of investment though the regular use the venture points cards by the card members. Such companies or venture funds would have a strong interest in promoting the venture fund card, not only because of the potential infusion of funds, but as a vehicle to disseminate information about potential investment opportunities, information required for compliance with securities laws and the like, information about individual holdings and news of the company, as well as a vehicle to identify appropriate and interested potential investors. The venture funds would have a ready, interested and previously identified pool of people (even if the venture funds are not provided with the actual identities, but rather the identified are held by an intermediary such as the card processor for instance), who might be interested in making additional investments. For instance, a fund might be directed to investing in biotechnology. The cardholders, by their selection of this biotechnology fund's venture points reward program, would have directly or inferentially identified themselves as interested in investing in biotechnology. If the card product was appropriately restricted to accredited investors, or the approval process for issuing the transaction card requires limited release of certain financial information about the cardholder (e.g., that the person qualifies as an accredited investor), the fund could then supply the cardholder with information about potential investments or about the fund itself to attract additional investments, or simply to supply news about the industry.

In addition to the rewards points potentially resulting in large gains, the fund or company benefiting from the investment could offer a form of purchase price discount through by issuing warranties or stock options, i.e., permitting the warranty or stock option holder to purchase stock at a priced fixed at an earlier time.

### Identifying Potential Cardholders

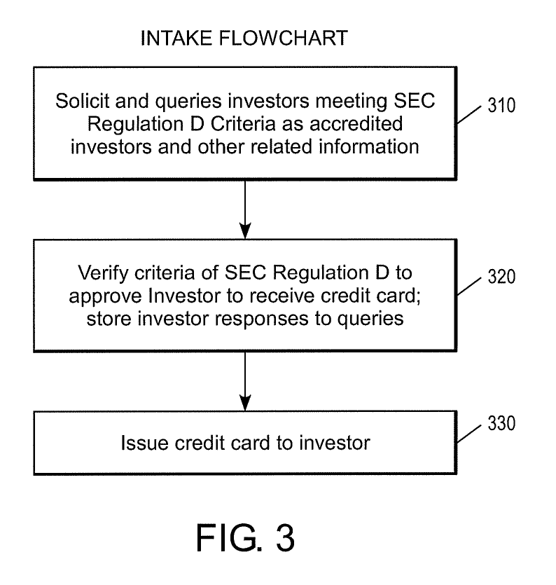

FIG. 3 illustrates the intake flowchart for finding appropriate potential investors, such as accredited investors (people who meet the previously described Securities Exchange Commission Regulation D criteria) for instance. These accredited investors or angels are solicited to obtain a credit card, that as its reward, deposits funds in a venture capital fund. (step 310). Such solicitation efforts can include direct personal contact with the accredited investor either via telephone or in person, or contact via the Internet or through a website of the product offerings, or through affinity groups such as angel investor groups, or associations focused on a given technology During the solicitation, the accredited investor can be asked a number of questions regarding their investment strategies, types of technologies and companies in which they like to invest, cultural or social affinities (e.g., affinity to minority owned companies), geographical preferences, product areas that the accredited investor considers to be areas of potential growth, or other similar questions regarding the accredited investor's interests or affinities.

In step 320, once the investors have been solicited to obtain the credit card product, whether the investor meets the criteria of SEC Regulation D must be verified in order to approve the investor for receipt of the credit card. Upon verification that the investor meets the Regulation D criteria, the credit card is issued to the investor in step 330. This also provides the card issuer with a list of persons that meet the criteria of an accredited investor or angel. In addition, the card issuer is provided with valuable information related to the investment affinities of each accredited investor. This affinity information can be analyzed to determine tendencies for investment, marketing information and other data related to the accredited investor.

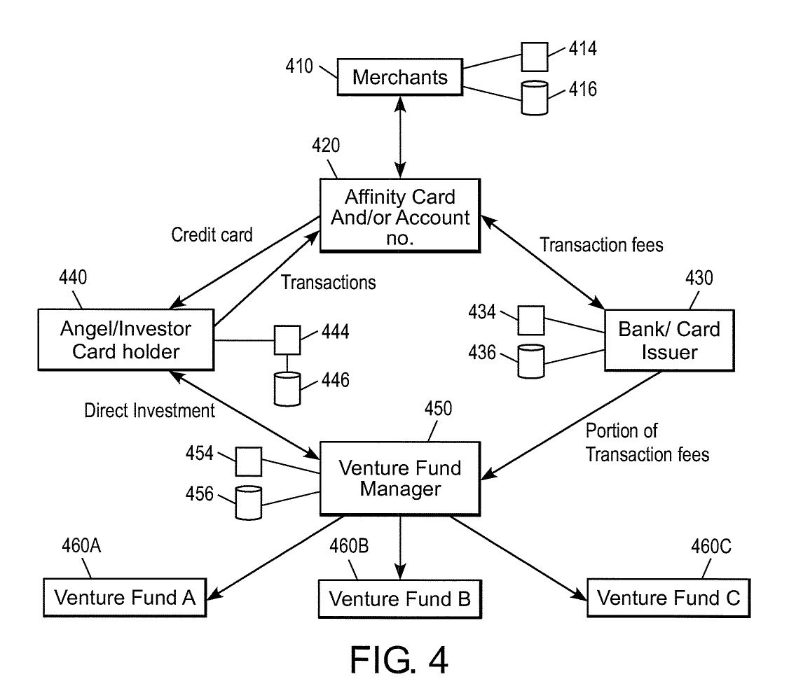

FIG. 4 illustrates the distribution of transaction fees in an exemplary embodiment of the present invention. The system 400 distributes transaction fees and information between merchants 410, bank card issuer 430, the venture fund manager 450 and angel/investor cardholder 440. The bank/card issuer 430 issues the credit card 420 and account number to the angel/investor cardholder 440 after the angel/investor cardholder has met the criteria as described above with reference to FIG. 3. The angel/investor cardholder 440 uses the credit card 420 to make purchases at merchant 410, the merchant 410 accepts the card and pays a transaction fee to the bank card/issuer 430. A portion of the transaction fees is dispersed by the bank/card issuer 430 to the venture fund manager 450 either as cash or as points to be converted periodically into cash. The portion of the transaction fee paid by the merchant 410 or cardholder to the bank/card issuer 430 are typically some percentage of the overall purchase made by the angel/investor card holder 440. A variety of methods of determining the portion of transaction fee to be distributed to the venture fund manager 450 can be envisioned.

The merchants 410 pay the transaction fees as a benefit in receiving the business of the angel/investor card holder 440, as is typical for all merchants that accept credit cards. The angel/investor card holder 440 benefits from having a line of credit from the bank/card issuer 430 as well as having the opportunity to invest in the venture fund managed by the venture fund manager 450. The venture manager 450 can manage any member of venture funds or a single venture fund as illustrated by venture fund A (460A), venture fund B (460B) and venture fund C (460C). The angel/investor card holder 440 may also have the opportunity to provide direct investment to the venture fund manager 450, who will apply the direct investment into a venture fund for the angel/investor card holder 440.

The angel/investor card holder 440 can also direct the venture fund manager 450 to distribute fractions of the portion of transaction fees received from bank card issuer 430 in the name of angel/investor cardholder 440 to a number of different venture funds, e.g., 10% to venture fund A (460a), 80% to venture fund B (460B), and 10% to venture fund C (460C) or 100% to venture fund A. Each portion of the transaction fees can either be held by the venture fund manager 450 to purchase a single share or a fraction thereof.

Alternatively, the venture fund manager can decide based on experience with the angel/investor card holder 440, angel/investor card holder 440 net worth, or amount of direct investment provided by angel/investor card holder 440, or other criteria, which of venture funds A, B or C that the direct investment dollars or portions of transaction fees attributable to the angel/investor card holder 440 will be invested.

The angel/investor card holder 440 can be, but are not necessarily, classified into a number of different classes of investor. For instance, an angel/investor card holder who infrequently uses the issued angel/investor card or pays a smaller annual fee can be considered a class 3 investor, whereas an angel/investor card holder who uses the angel/investor card more often or pays more in the way of an annual fee can be classified as a class 2 investor, and a class 1 investor can be an angel/investor card holder who uses the card almost exclusively or pays a relatively higher annual fee. Of course, the classifications of investors can be based on other factors or combination of factors, such as investor net worth, or total dollar purchases, status with the industry or fund, etc. For instance, although the accredited investor only uses the angel/investor card once a year, that purchase may be for the maximum amount of credit that is extended to the angel/investor, or the investor has some status as a founder in a company or luminary in the industry.

Not only does the venture fund manager 450 and the venture fund A, B or C, benefit from the relationship with the angel/investor card holder 440, but the angel/investor card holder 440 also benefits by being able to invest in a venture capital fund that may possibly invest in a company that will return a high-percentage rate of return based on the amount invested.

A plurality of computer servers, databases and connections are used to implement the above described process. The merchants use servers 414 and database 416 to possibly store data regarding the angel/investor 440, and communicate some or all of the stored information to the bank/card issuer 430. The bank/card issuer 430 maintains servers 434 and databases 436, so as to provide transaction verification/authorization and other information to the merchants 410. In addition, the bank/card issuer 430 can process and store information related to the angel/investor 440, affinity card 420, the merchants 410 and the venture fund manager 450. The bank/card issuer 430 also exchanges information regarding the transactions and/or the rewards earned by the angel/investor 440 with the venture fund manager 450.

The venture fund manager 450 also maintains servers 454 and databases 456, which it uses to process and store information regarding the angel/investor 440, the venture funds 460A-C, and the other investment or investor related information in this exemplary embodiment. The angel/investor 440 also can have a personal computer or server 444 with a storage device 446, which the angel/investor 440 uses to maintain their investments and reward points associated with affinity card 420. The angel/investor 440 can communicate with the bank/card issuer 330 and the venture fund manager 450 or the venture funds 460A-460C. The communication between each of the above entities can be over the Internet or some other network.

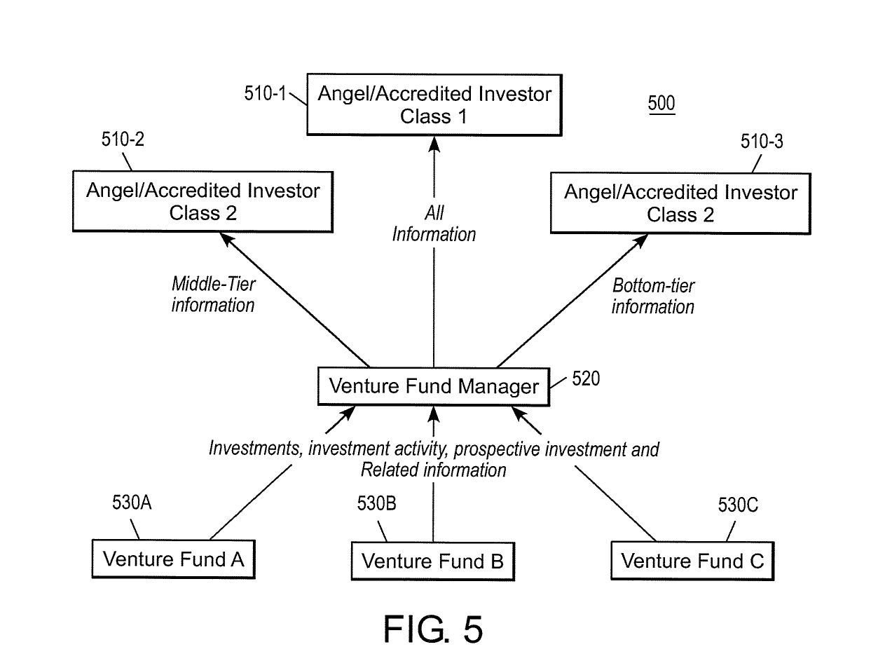

FIG. 5 illustrates the distribution of information related to each of venture fund A (530A), venture fund B (530B) and venture fund C (530C) to each of the different classes of angel/investor card holder. The classes of investors/cardholders and/or the selective and different levels of information distribution are optional, but may provide greater incentives to use of the venture fund card in order to achieve the next level. For instance, angel/credit investor class 1 (510-1) might receive all information that the venture fund manager receives from each of the venture funds A (530A), B (530B), C (530C) or is otherwise made available, including opinions of third party analysts, Dun and Bradstreet™ reports, visualization and other investment tools, etc. The information can also include areas of investment, investment activity, perspective investments and related information such as budgets for investing, technology in which each of the venture funds are currently involved as well as relationships of the companies receiving money from other investment firms or businesses.

A class 2 angel/credit investor 510-2 would receive less information, such as present investment trading activity but not the perspective investments or the related information as would the class 1 investor 510-1, to give one non-limiting example.

Finally, the class 3 investor 510-3 in this exemplary implementation would receive even less information and/or tools which, as a non-limiting example may only include the investments into which his portion of transaction fees or direct investment were invested for that particular cardholder.

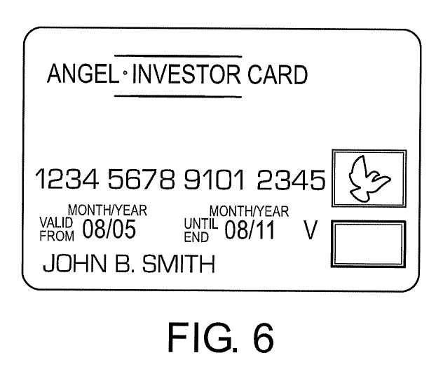

FIG. 6 illustrates an exemplary venture card product.

The present invention has been described by way of exemplary embodiments to which it is not limited. Variations and modifications will occur to those skilled in the art without departing from the scope of the invention.

What is claimed is:

1. A process of controlling transaction cards to provide benefits of a rewards program contribution to a venture fund, comprising the steps of:
permitting a potential investor to apply for a venture fund transaction card;
approving and issuing venture fund transaction cards to qualified cardholders as a result of a review of their qualifications against predetermined criteria;
permitting use of issued transaction cards after a check on whether the use of the transaction card is appropriate at the time of the transaction, to make purchases of one or more of products and services;
taking a portion of the transaction value of a transaction to be used by one or more venture funds; and
providing cardholders an opportunity to liquidate investments in said one or more venture funds.

2. The process of claim 1, further comprising issuing statements to individual cardholders having additional information regarding fund or funds in which the cardholder has invested or might be interested in investing.

3. The process of claim 1, further comprising
providing cardholders the option to increase holdings in a particular venture fund associated with the venture fund card.

4. The process of claim 1, further comprising soliciting potential investors having said predetermined criteria qualifications to apply for the venture fund transaction card through marketing directed to those interested in a particular affinity category.

5. The process of claim 1, wherein the step of permitting a potential investor to apply for a venture fund transaction card includes an application process requiring the potential investor to supply information about his finances and his interests in investing in venture funds.

6. The process of claim 1, wherein the step of approving and issuing venture fund transaction cards to qualified cardholders includes determining the potential investors qualification as an accredited investor through a self-certification process.

7. The process of claim 1, wherein the step of taking a portion of the transaction value of a transaction and providing said portion to one or more venture funds includes providing funds to a venture fund manager, wherein the venture fund manager places the said portion of the transaction value as an investment in a venture fund and keeping another portion as a management fee.

8. The process of claim 5, wherein said portion of the transaction value is placed in a start-up company.

9. The process of claim 1, wherein the step of taking a portion of the transaction value of a transaction and providing said portion to one or more venture funds includes permitting the cardholder to select a venture fund from a plurality of venture funds.

10. The process of claim 1, wherein the step of issuing statements to individual cardholders having additional information regarding fund or funds in which the cardholder has invested includes at least one of information from third party analysts and investment tools.

11. The process of claim 1, wherein the step of providing cardholders the option to increase holdings in a particular venture fund associated with the venture fund card includes additional transactions, separate and apart from the transactions associated with the venture fund card, in which additional security interests are purchased.

12. The process of claim 1, wherein the step of providing cardholders an opportunity to liquidate investments in said one or more venture funds include at least one of permitting liquidation through public offerings, permitting liquidation by way of the company being merged or acquired by another company, and permitting liquidation through a private equity market whose participants are also venture card holders.

13. The process of claim 1, wherein the step of providing cardholders an opportunity to liquidate investments includes converting said holdings in a venture fund into cash.

14. A computer system configured to carrying out the process of claim 1.
